(19) United States
(12) Patent Application Publication
(10) Pub. No.: US 2019/0006791 A1
(43) Pub. Date: Jan. 3, 2019

(54) Cable Strain Relief Device With Grip Member

(71) Applicants: Shane Holley, Windermere, FL (US); Karl St. George, Phetchaburi (TH)

(72) Inventors: Shane Holley, Windermere, FL (US); Karl St. George, Phetchaburi (TH)

(21) Appl. No.: 15/753,591

(22) PCT Filed: Aug. 22, 2016
(86) PCT No.: PCT/US2016/048051

§ 371 Date: Feb. 20, 2018

Related U.S. Application Data
(60) Provisional application No. 62/207,434, filed on Aug. 20, 2015.

(51) Int. Cl. H01R 13/58; H01R 13/506; H01R 43/18

(52) U.S. Cl. CPC H01R 13/5812; H01R 43/18; H01R 13/506

(57) ABSTRACT

An electrical cable connector assembly with strain relief includes a rigid housing and a grip member. The rigid housing has a housing body defining an interior space. The interior space receives an electrical cable and an electronic plug. The interior space surrounds an electrical connection between the electrical cable and electronic plug to prevent strain on the electrical connection. The grip member has a bulbous grip member body defining a cavity into which the rigid housing extends. The bulbous grip member body has an interior surface forming a wall of the cavity and an exterior surface forming an exterior perimeter of the grip member. The exterior surface has a major dimension approximating the size of a human fingertip.

### CROSS-REFERENCE TO RELATED APPLICATION

This claims the benefit of U.S. provisional Application No. 62/207,434, which was filed Aug. 20, 2015 and is incorporated by reference herein in its entirety.

### FIELD

This relates to the field of electronic devices and, more particularly, to electronic device cables.

### BACKGROUND

Small cables are often used to connect electronic devices such as computers, mobile phones, media players, tablets, etc. to electrical outlets or to other electronic devices. Because of this, the cables are constantly handled, connected and stored and suffer strain, abuse, and damage—they are plugged, unplugged, tugged, wrapped in coils, and wrapped in knots. It is no surprise, therefore, that the cables used with these types of devices suffer damage and break often, routinely where the cable portion itself merges with the connector because of the strain placed on the cable at that location during use, connection, disconnection, or storage.

These cables also have connectors configured to connect with specific electrical devices such as specific types of mobile phones. Many of these connectors are small and can be difficult to grab and position for users with limited dexterity due to age or conditions such as arthritis.

### BRIEF SUMMARY

Improvements to strain relief devices are needed because many conventional strain relief devices are so small that the user cannot manipulate them very easily. In view of the foregoing, it would be advantageous to have a strain relief device for a cable that includes a grip member for ease of plugging and unplugging and may protect and strengthen the cable at or near the point of connection with the electronic device.

In a first example embodiment, an electrical cable connector assembly with strain relief includes a rigid housing and a grip member. The rigid housing has a housing body defining an interior space, the interior space receiving an electrical cable and an electronic plug, the interior space surrounding an electrical connection between the electrical cable and electronic plug to prevent strain on the electrical connection. The grip member has a bulbous grip member body defining a cavity into which the rigid housing extends, the bulbous grip member body having an interior surface forming a wall of the cavity and an exterior surface forming an exterior perimeter of the grip member. The exterior surface having a major dimension approximating the size of a human fingertip.

In a second example embodiment, an electronic cable assembly includes an electronic cable having a first device connector on a first end and a second device connector on a second end. The first and second device connectors include a rigid housing and a plug, the rigid housing covering an electrical connection between cable wiring and the plug. At least one of the device connectors also includes a grip member having a bulbous grip member body defining a cavity into which the rigid housing extends. The bulbous grip member body has an interior surface forming a wall of the cavity and an exterior surface forming an exterior perimeter of the grip member. The exterior surface has a major dimension approximating the size of a human fingertip.

In a third example embodiment, a method of making an electrical cable includes obtaining a grip member having a bulbous grip member body defining a cavity, the bulbous grip member body having an interior surface forming a wall of the cavity and an exterior surface forming an exterior perimeter of the grip member, the exterior surface having a major dimension approximating the size of a human fingertip. The grip member is positioned on an electrical cable by passing the electrical cable through the cavity. The grip member is slid along the electrical cable and onto a rigid housing. The rigid housing has a housing body defining an interior space, the interior space receiving the electrical cable and an electronic plug, the interior space surrounding an electrical connection between the electrical cable and electronic plug to prevent strain on the electrical connection.

The following feature may be included in any of these three example embodiments.

The cavity may include a first interlocking component and the housing body may include a second interlocking component that mates with the first interlocking component and secures the grip member to the rigid housing.

One of the first or second interlocking component may be a protrusion and the other of the first or second interlocking component may be a recess and the protrusion fits snugly within the recess when the first and second interlocking components are mated.

The first interlocking component may be a protrusion and second interlocking component may be a recess and the protrusion fits snugly within the recess when the first and second interlocking components are mated.

The bulbous grip member body may be made of a monolithic piece of material.

The major dimension may be 1 to 4 mm.

The bulbous grip member body may have a substantially circular cross-section.

### BRIEF DESCRIPTION OF THE DRAWINGS

FIG. 1 is a side view of an example of a conventional cable assembly;

FIG. 2 is a rear perspective view of a first embodiment of a cable strain relief device installed on a cable;

FIG. 3 is a front perspective view thereof;

FIG. 4 is a top view thereof;

FIG. 5 is a top view thereof showing hidden features in broken lines;

FIG. 6 is a side view thereof showing hidden features in broken lines;

FIG. 7 is a back view of an example of the grip member;

FIG. 8 is a top cutaway view thereof;

FIG. 9 is a side cutaway view thereof;

FIG. 10 is a top view of an example of the cable housing;

FIG. 11 is a side view thereof;

FIG. 12 is a diagram showing a method of installing the grip member;

FIG. 13 is a top view of the strain relief device showing a lighted embodiment of the housing;

FIG. 14 is a top view of the embodiment of FIG. 13 with a transparent or translucent grip member over the housing;

FIG. 15 is a top view of the strain relief device showing another embodiment of the housing with the grip member removed;

FIG. 16 is a top view of the strain relief device of

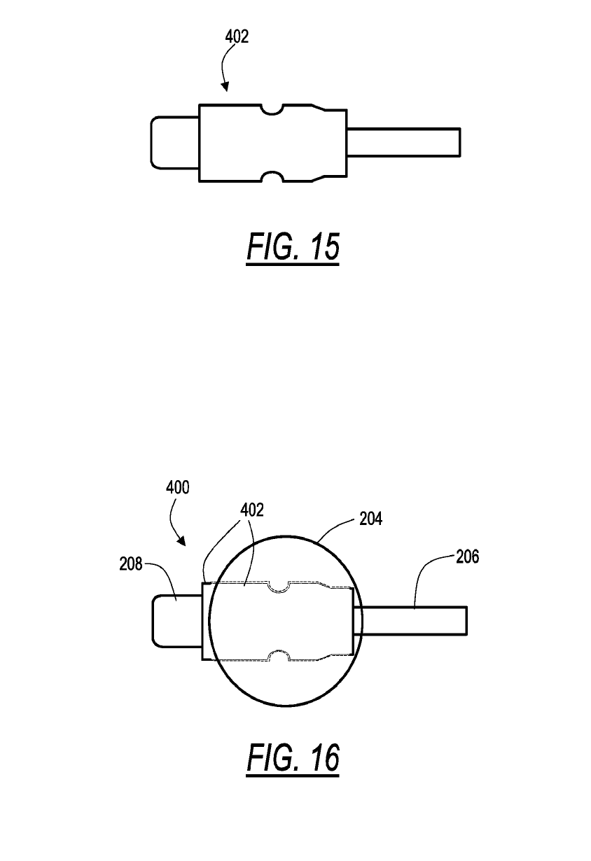

FIG. 15 with the grip member over the housing;

FIG. 17 is a perspective view of another embodiment of the strain relief device;

FIG. 18 is a perspective view of yet another embodiment of the strain relief device; and

FIG. 19 is a top view of another embodiment of the strain relied device showing hidden features in broken lines.

### DETAILED DESCRIPTION OF EXAMPLE EMBODIMENTS

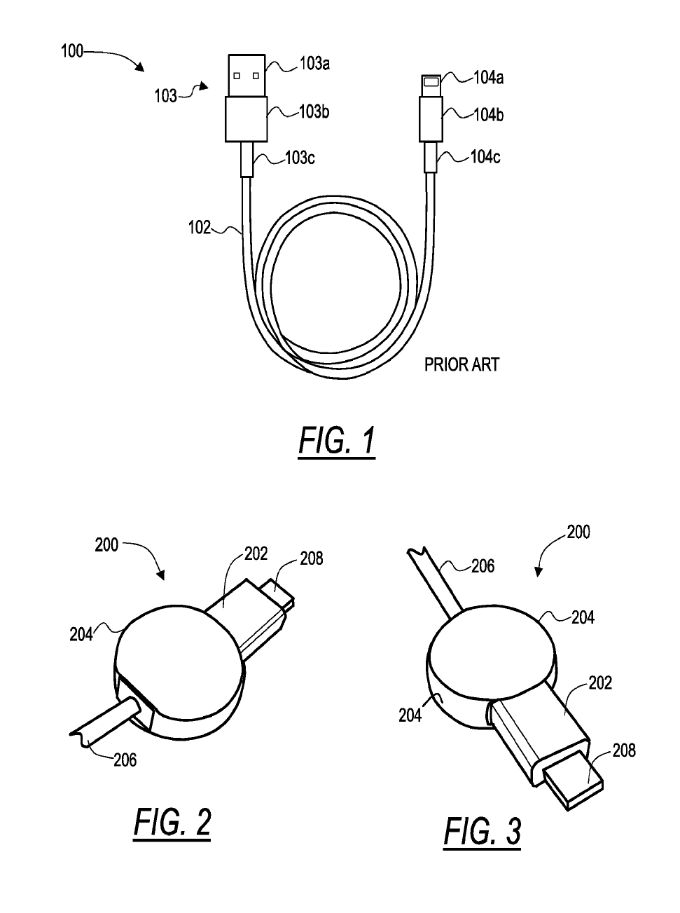

In FIG. 1 a conventional prior art device cable assembly 100 is depicted and is discussed here to provide an initial frame of reference. The cable assembly 100 includes a cable 102 that has two ends fitted with two common connector types. The connector 103 positioned at a first end of the cable, shown on the left of FIG. 1, is a USB-A connector and the connector 104 at a second end of the cable, shown on the right of FIG. 1 is a mobile phone connector commonly marketed as a lightning connector. Each connector includes a plug 103a, 104a, a housing 103b, 104b, and a cable cover 103c, 104c. The plug 103a, 104a connects into a mating receptacle of a device such as a mobile phone. The housing 103b, 104b covers the wiring connections between the plug 103a, 104a and the cable 102. The cable cover 103c, 104c extends partially down the cable 102 from the housing 103b, 104b.

With such conventional cable assemblies, the cables frequently break where the cable 102 and housing 103b, 104b meet or where the cable 102 and cable cover 103c, 104c meet. Another problem with these types of conventional cable assemblies is that people frequently unplug them by holding and pulling on the cable 102 rather than holding the connectors 103,104 because the connectors 103,104 are too small to grip.

The strain relief device disclosed in this application is adapted to be used on many different types of cables, but is particularly advantageous for use on device cables having, for example, USB-A, USB-B, mini-USB, micro-USB, dock connectors, lightning connectors, or any other device cable. Our strain relief device is advantageous because it provides a grip member that people can grip when unplugging the cable and may also provide protection and added strength at the connection of the connectors and the cable.

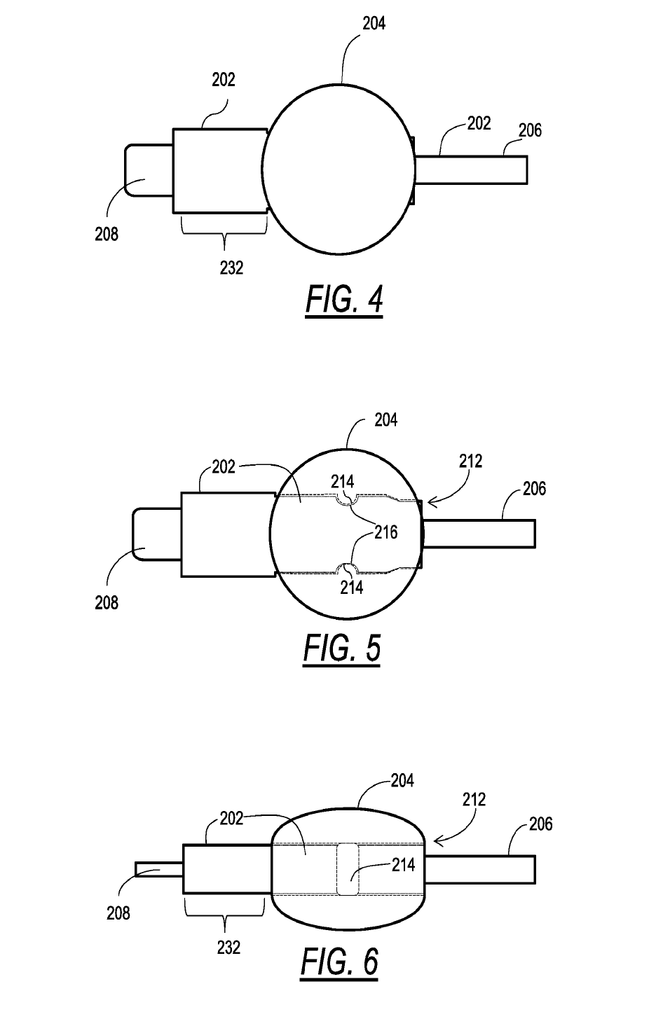

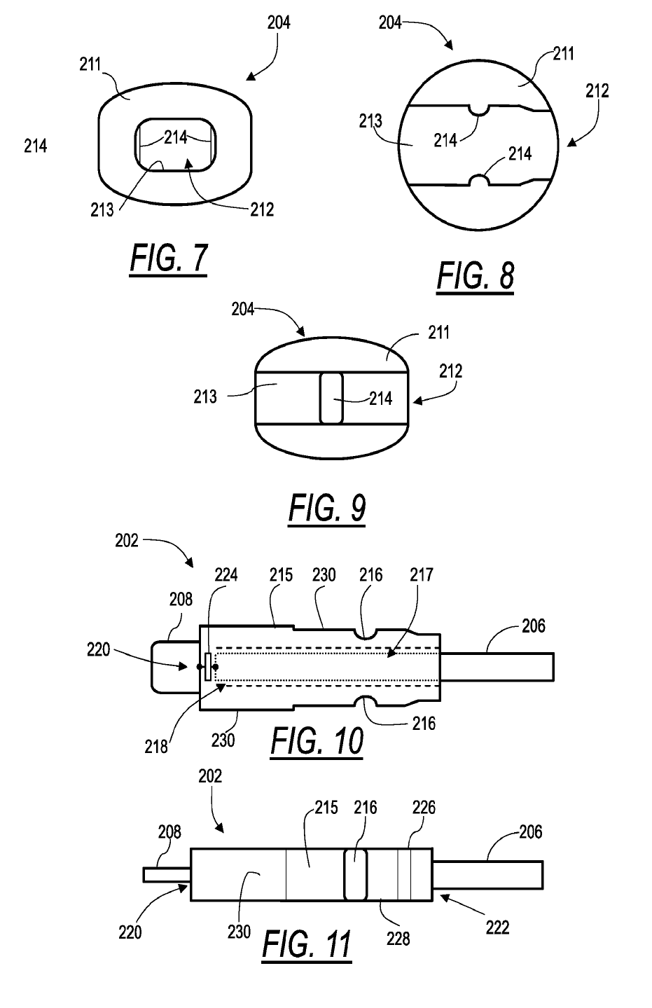

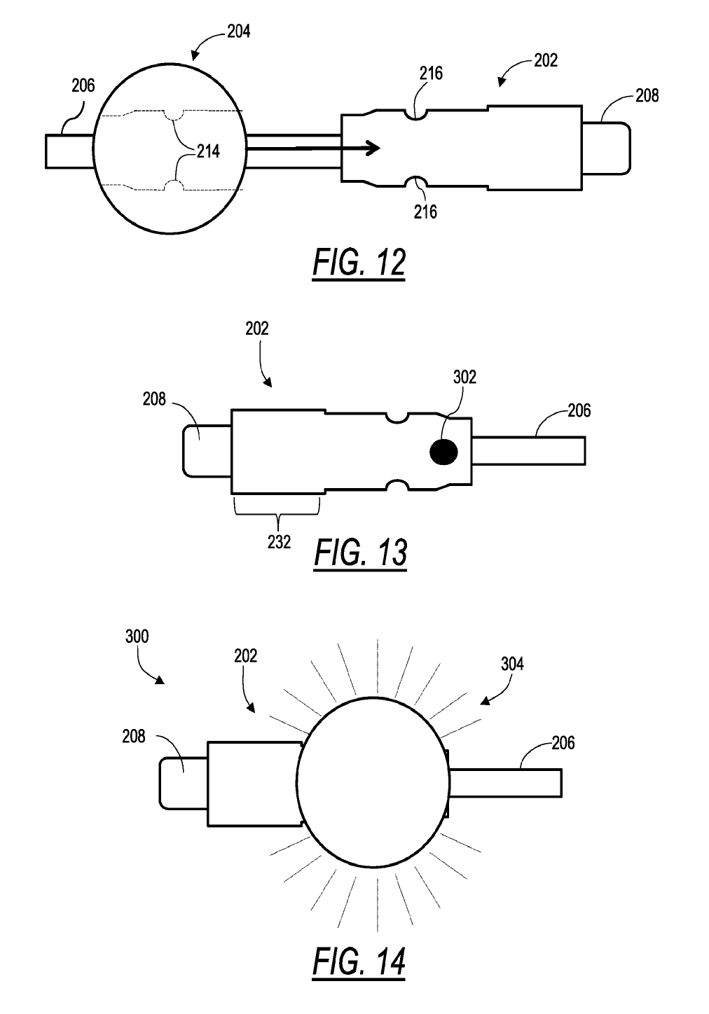

A first embodiment of the strain relief device 200 will now be discussed by referring to FIGS. 2-11. The strain relief device 200 includes a housing 202 and a grip member 204 positioned over the housing. The device 200 is shown installed on a cable assembly having a cable 206 and a plug 208.

The grip member 204 provides an enlarged section of material 200 that people can easily grip for unplugging the plug 208 without pulling on the cable 206. The housing 202 covers the wiring connections between the cable 206 and the plug 208 and prevents strain on the cable and its electrical components and electrical connections. The grip member 204 and housing 202 are secured together by a securing mechanism such as, for example, friction, adhesive, clamping, interlocking portions, or the like. The grip member and housing may alternatively be made of a monolithic single-piece body of unitary construction.

The grip member 204 can have many different shapes. It is therefore, not limited to the substantially ovoid shape shown in the drawings. In general, the grip member 204 is designed to be held by gripping in plugging and unplugging the plug 208 of the cable assembly 200. The grip member 204 may have smooth surfaces or edges (if any edges) and its size approximates that of a human fingertip. Alternatively, the grip member 30 may have gripping ribs or other protrusions that facilitate gripping. A typical major dimension of the grip member is about 1 cm to about 4 cm or about 1 cm to about 3 cm. The major dimension refers to the distance between the two farthest points on the grip member 204 measured from a central axis of the grip member which axis extends along the length of the cable extending between the two ends of the cable.

The grip member 204 is made of a material that is not irritating to the touch because it is meant to be gripped. Suitable materials for making the grip member 204 include rubbers, plastics, or the like. The grip member 204 may be made of a resilient material so that it can compress when squeezed between the fingers but retain its original shape after release. The grip member 204 may be molded to the desired shape and may be formed as a monolithic piece of material or may be constructed in multiple pieces that fit together.

As best shown in FIGS. 7-9, the grip member 204 includes a grip member body 211, defining an interior cavity 212 within the grip member body. The cavity 212 may be, as shown, an opening that passes completely through the grip member body 211. The cavity 212 includes an interior surface 213 having a pair of protrusions 214 formed along opposed sides of the interior surface 214. The protrusions 214 form a part of the securing mechanism for attaching the grip member 204 to the housing 202. The size of the cavity 212 is such that the housing 202 will fit snugly within the opening 212. Substantially all of the interior surface 214 may, if desired, be in contact with the housing 202 to enhance the friction between the grip member 204 and housing 202.

As best shown in FIGS. 10 and 11, the housing 202 includes a hollow housing body 215 defining an interior space 217. The housing 202 receives the plug into the interior space 217 at a plug end 220 and receives the cable 206 into the interior space 217 at a cable end 222. The plug 208 and cable are connected via an electrical connection 224 in the interior space 222. The housing 202 extends over at least part of the cable 206 to provide strain relief for the electrical connection 224.

The housing body 215 includes a top surface 226, bottom surface 228, and a pair of opposed side surfaces 230. Each of the side surfaces 230 define a recess 216 that mates with a corresponding protrusion 214 of the grip member 204 and forms another portion of the securing mechanism. Mating the recesses 216 with protrusions 214 further secures the grip member 204 to the housing 202 by interlocking together. If desired, the grip member 204 and housing 202 may be slidably released from one another by pulling the grip member 204 off the housing 202.

The housing 202 is made of a material such as rubber, plastic, or the like. The housing 202 may be formed to the desired shape as a monolithic piece of material by molding, extrusion, or other like methods or may constructed in multiple pieces that fit together.

Referring to FIG. 12, the cable assembly 200 may be made by applying the grip member 204 over the housing 202. In the example shown, the grip member 206 is placed around the cable 206, slid along the length of the cable 206, and then slid around the housing 202 as indicated by the arrow. The grip member 204 is then secured to the housing 202 by mating the protrusions 214 with the recesses 216.

Referring to FIGS. 13 and 14, a cable assembly 300 including another embodiment of the strain relief device includes a light 302 that illuminates when the cable is plugged into a power source. By way of example, a cable that includes a USB-A plug can distribute electricity from the USB-A plug through the cable wiring. The light 302 in the embodiment shown is contained within the housing 202. The housing 202 is, in turn, at least partially translucent or transparent so that the beam from the light can be seen. Likewise, the grip member 304 is also at least partially translucent or transparent so that the grip member 304 has a lighted or glowing appearance when the light is on. This lighted embodiment is advantageous because it provides a mechanism to locate the cable assembly 300 in the dark.

In the embodiment of FIGS. 2-12, the housing 202 includes a forward section 232 that extends forward between the grip member 204 and plug end 220. This forward section 232 is advantageous to allow the plug 208 to be plugged into a device that is within a case. For many conventional cable assemblies, a case will prevent the plug 204 from being able to reach the corresponding receptacle on the device. The forward section 232 effectively provides an extension that is small enough to fit through the cable opening in the device case.

It is to be understood that the term “plug” may be a male-type plug as shown or a female-type receptacle.

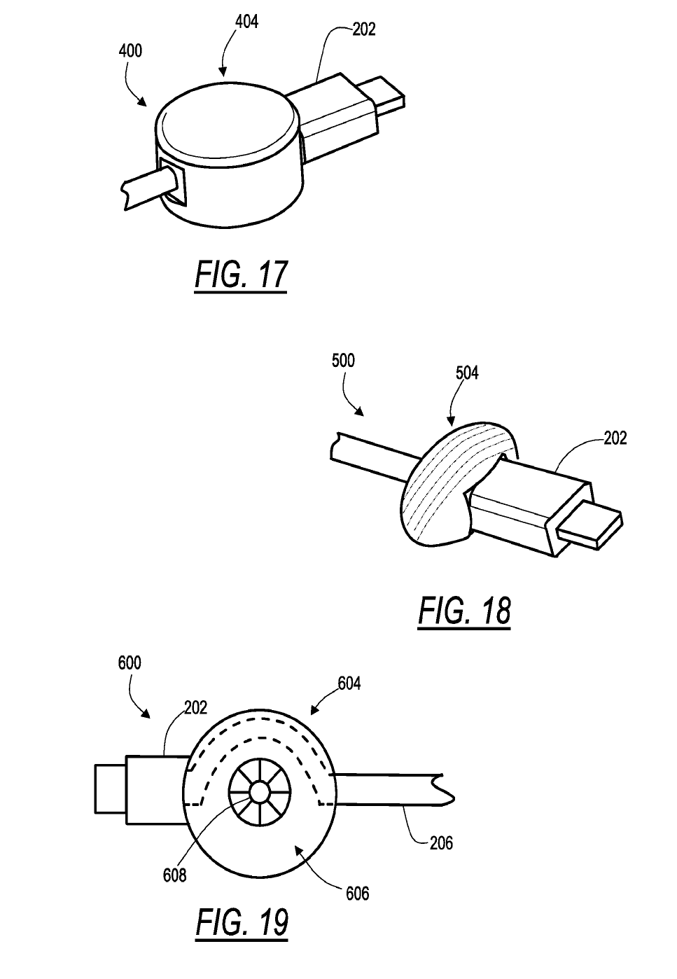

The forward section is not necessarily present in each embodiment. In the embodiment of FIGS. 15 and 16, the housing 402 does not include the forward section such that the grip member 204 substantially covers the housing 202.

As mentioned above, the grip member 204 may have many different shapes besides the ovoidal shape shown in FIGS. 2-12. By way of example, the cable assembly 400 of FIG. 17 includes a substantially cylindroidal shaped grip member 404 and the cable assembly 500 of FIG. 18 includes a substantially prolate spheroidal shaped grip member 504.

Referring now to FIG. 19, yet another embodiment of the cable assembly 600 includes a substantially toroidal shaped grip member 604 having a hollow interior cavity 606 through which the cable 200 passes. In this embodiment, the cable assembly 600 emulates the shape of a tire having a hub-like member 608 at the center of the grip member 604.

This disclosure describes some example embodiments, but not all possible embodiments. Where a particular feature is disclosed in the context of a particular example embodiment, that feature can also be used, to the extent possible, in combination with and/or in the context of other embodiments. The cable strain relief device with grip member may be embodied in many different forms and should not be construed as limited to only the embodiments described here.

That which is claimed is:

1. An electrical cable connector assembly with strain relief, the assembly comprising:
a rigid housing having a housing body defining an interior space, the interior space receiving an electrical cable and an electronic plug, the interior space surrounding an electrical connection between the electrical cable and electronic plug to prevent strain on the electrical connection; and
a grip member having a bulbous grip member body defining a cavity into which the rigid housing extends, the bulbous grip member body having an interior surface forming a wall of the cavity and an exterior surface forming an exterior perimeter of the grip member, the exterior surface having a major dimension approximating the size of a human fingertip.

2. The electrical cable connector assembly with strain relief of claim 1, wherein the cavity includes a first interlocking component and the housing body includes a second interlocking component that mates with the first interlocking component and secures the grip member to the rigid housing.

3. The electrical cable connector assembly with strain relief of claim 2, wherein one of the first or second interlocking component is a protrusion and the other of the first or second interlocking component is a recess and the protrusion fits snugly within the recess when the first and second interlocking components are mated.

4. The electrical cable connector assembly with strain relief of claim 2, wherein the first interlocking component is a protrusion and second interlocking component is a recess and the protrusion fits snugly within the recess when the first and second interlocking components are mated.

5. The electrical cable connector assembly with strain relief of claim 1, wherein the bulbous grip member body is made of a monolithic piece of material.

6. The electrical cable connector assembly with strain relief of claim 1, wherein the major dimension is 1 to 4 mm.

7. The electrical cable connector assembly with strain relief of claim 1, wherein the bulbous grip member body has a substantially circular cross-section.

8. The electrical cable connector assembly with strain relief of claim 1, wherein:
wherein the cavity includes a first interlocking component and the housing body includes a second interlocking component that mates with the first interlocking component and secures the grip member to the rigid housing;
the first interlocking component is a protrusion and second interlocking component is a recess and the protrusion fits snugly within the recess when the first and second interlocking components are mated;
the bulbous grip member body is made of a monolithic piece of material;
the major dimension is 1 to 4 mm; and
the bulbous grip member body has a substantially circular cross-section.

9. An electronic cable assembly comprising:
an electronic cable having a first device connector on a first end and a second device connector on a second end, each device connector including a rigid housing and a plug, the rigid housing covering an electrical connection between cable wiring and the plug; at least one of the device connectors including:
a grip member having a bulbous grip member body defining a cavity into which the rigid housing extends, the bulbous grip member body having an interior surface forming a wall of the cavity and an exterior surface forming an exterior perimeter of the grip member, the exterior surface having a major dimension approximating the size of a human fingertip.

10. The electronic cable assembly of claim 9, wherein the cavity includes a first interlocking component and the housing includes a second interlocking component that mates with the first interlocking component and secures the grip member to the housing.

11. The electronic cable assembly of claim 10, wherein one of the first or second interlocking component is a protrusion and the other of the first or second interlocking component is a recess and the protrusion fits snugly within the recess when the first and second interlocking components are mated.

12. The electronic cable assembly of claim 10, wherein the first interlocking component is a protrusion and second interlocking component is a recess and the protrusion fits snugly within the recess when the first and second interlocking components are mated.

13. The electronic cable assembly of claim 9, wherein the bulbous grip member body is made of a monolithic piece of material.

14. The electronic cable assembly of claim 9, wherein the major dimension is 1 to 4 mm.

15. The electronic cable assembly of claim 9, wherein the bulbous grip member body has a substantially circular cross-section.

16. The electronic cable assembly of claim 9, wherein:
wherein the cavity includes a first interlocking component and the housing includes a second interlocking component that mates with the first interlocking component and secures the grip member to the housing;
the first interlocking component is a protrusion and second interlocking component is a recess and the protrusion fits snugly within the recess when the first and second interlocking components are mated;
the bulbous grip member body is made of a monolithic piece of material;
the major dimension is 1 to 4 mm; and
the bulbous grip member body has a substantially circular cross-section.

17. A method of making an electrical cable, the method comprising:
obtaining a grip member having a bulbous grip member body defining a cavity, the bulbous grip member body having an interior surface forming a wall of the cavity and an exterior surface forming an exterior perimeter of the grip member, the exterior surface having a major dimension approximating the size of a human fingertip;
positioning the grip member on an electrical cable by passing the electrical cable through the cavity; and
sliding the grip member along the electrical cable and onto a rigid housing having a housing body defining an interior space, the interior space receiving the electrical cable and an electronic plug, the interior space surrounding an electrical connection between the electrical cable and electronic plug to prevent strain on the electrical connection.

18. The method of making an electrical cable of claim 17, wherein the cavity includes a first interlocking component and the housing body includes a second interlocking component that mates with the first interlocking component and secures the grip member to the housing body.

19. The method of making an electrical cable of claim 18, wherein one of the first or second interlocking component is a protrusion and the other of the first or second interlocking component is a recess and the protrusion fits snugly within the recess when the first and second interlocking components are mated.

20. The method of making an electrical cable of claim 18, wherein the first interlocking component is a protrusion and second interlocking component is a recess and the protrusion fits snugly within the recess when the first and second interlocking components are mated.

21. The method of making an electrical cable of claim 17, wherein the bulbous grip member body is made of a monolithic piece of material.

22. The method of making an electrical cable of claim 17, wherein the major dimension is 1 to 4 mm.

23. The method of making an electrical cable of claim 17, wherein the bulbous grip member body has a substantially circular cross-section.

24. The method of making an electrical cable of claim 17, wherein:
wherein the cavity includes a first interlocking component and the housing body includes a second interlocking component that mates with the first interlocking component and secures the grip member to the housing body;
the first interlocking component is a protrusion and second interlocking component is a recess and the protrusion fits snugly within the recess when the first and second interlocking components are mated;
the bulbous grip member body is made of a monolithic piece of material;
the major dimension is 1 to 4 mm; and
the bulbous grip member body has a substantially circular cross-section.
